(19) United States
(12) Patent Application Publication
(10) Pub. No.: US 2018/0123245 A1
(43) Pub. Date: May 3, 2018

(54) BROADBAND ANTENNA ARRAY FOR WIRELESS COMMUNICATIONS

(71) Applicant: Broadcom Corporation, Irvine, CA (US)

(72) Inventors: Ana PAPIÓ TODA, Irvine, CA (US); Seunghwan YOON, Irvine, CA (US); Leonard Thomas HALL, Golden Grove (AU); Chryssoula KYRIAZIDOU, Kifisia (GR); Alfred GRAU BESOLI, Barcelona (ES)

(21) Appl. No.: 15/338,265

(22) Filed: Oct. 28, 2016

(51) Int. Cl. H01Q 5/50; H01Q 1/48; H01Q 1/22; H01Q 1/36; H01Q 21/00; H01Q 9/04

(52) U.S. Cl. CPC H01Q 5/50; H01Q 1/48; H01Q 9/0414; H01Q 1/36; H01Q 21/0075; H01Q 1/2291

(57) ABSTRACT

A broadband antenna element for wireless communications includes one or more radiator layers to receive an electrical signal and to transmit a polarized electromagnetic (EM) wave. A feed layer including a feeding mechanism feeds the electrical signal generated by a transmitter into the radiator layer. A ground layer is coupled to a ground potential of the transmitter. The one or more radiator layers, the feed layer, and the ground layer are conductor layers of a multilayer substrate that includes metal layers and dielectric layers. The antenna element transmits with a broad bandwidth centered at a frequency of about 60 GHz, and maintains the broad bandwidth and polarization purity for scan angles up to a predefined value.

### TECHNICAL FIELD

The present description relates generally to wireless communications, and more particularly, to a broadband antenna array for wireless communications.

### BACKGROUND

As the use of telecommunication and the desire for higher speed data transfer is increased, new technologies for making higher speed communication device and systems are developed. For example, for short-range communications, Wireless Gigabit Alliance (WiGig) protocol is viewed as a complement for high-speed Wi-Fi that can address short-range communication needs. The WiGig specification allows devices to communicate without wires at multi-gigabit speeds up to 60 GHz. High performance wireless data display and audio applications as well as backhaul applications can be enabled that supplement the capabilities of previous wireless LAN devices.

The WiGig technology at 60 GHz used for the latest wireless systems provides high-speed point-to-point connections, for example, for high definition and 3D TV signals from the set-top-box to a large screen TV and for backhaul applications. Further, the 60 GHz technology, built into smartphones and other portable devices, allows transfer of HD video from a portable device to a TV screen for display.

### BRIEF DESCRIPTION OF THE DRAWINGS

Certain features of the subject technology are set forth in the appended claims. However, for purposes of explanation, several embodiments of the subject technology are set forth in the following figures.

FIG. 1 is a high-level diagram illustrating an example of a broadband antenna element for wireless communications according to aspects of the subject technology.

FIGS. 2A through 2D are diagrams illustrating example structural views of a broadband multi-patch antenna element for wireless communications according to aspects of the subject technology.

FIGS. 3A through 3D are diagrams illustrating example structural views of a broadband edge-dipole antenna element for wireless communications according to aspects of the subject technology.

FIGS. 4A through 4E are diagrams illustrating example characteristics of the edge-dipole antenna element of FIG. 3A according to aspects of the subject technology.

FIGS. 5A through 5C are diagrams illustrating examples of a broadband half-mode substrate-integrated waveguide (HMSIW) antenna element for wireless communications according to aspects of the subject technology.

FIGS. 6A-6B are diagrams illustrating example characteristics of the HMSIW antenna element of FIG. 5A according to aspects of the subject technology.

FIGS. 7A through 7E are diagrams illustrating example configurations of a broadband folded-patch antenna element for wireless communications according to aspects of the subject technology.

FIGS. 8A-8B are diagrams illustrating example characteristics of the folded-patch antenna element of FIG. 7B according to aspects of the subject technology.

FIGS. 9A through 9F are diagrams illustrating examples of a broadband cavity-slot antenna element for wireless communications according to aspects of the subject technology.

FIG. 10 is a diagram illustrating an example characteristic of the cavity-slot antenna element antenna of FIG. 9A according to aspects of the subject technology.

FIGS. 11A-11B are diagrams illustrating a top view and a perspective view, respectively, of an example of a ring antenna element for wireless communications according to aspects of the subject technology.

FIG. 12 is flow diagram illustrating a method of providing a broadband antenna element for wireless communications according to aspects of the subject technology.

FIG. 13 is a block diagram illustrating an example wireless communication device in accordance with one or more implementations of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without one or more of the specific details. In some instances, structures and components are shown in block diagram form in order to avoid obscuring the concepts of the subject technology.

In one or more aspects of the subject technology, broadband antenna elements for high speed (e.g., 60 GHz) wireless communications are provided. The subject technology enables broad bandwidth (e.g., about 57-66 GHz) antenna elements with margins (e.g., ˜1 GHz) on the band edges to account for fabrication tolerances such as displacements or misalignments of structural components. Further, the disclosed solutions allow the bandwidth of the antenna element to be maintained for large scan angles (e.g., up to 60 degrees) as the antenna beam of the antenna array is steered. In addition, the antenna elements of the subject technology preserve polarization (e.g., linear, dual, or circular polarization) purity within the full bandwidth of the antenna elements and for nearly all scan angles of the antenna array. The disclosed antenna elements, when used in antenna arrays, enable reduction of surface modes by avoiding diffraction at the antenna array edges and low coupling among antenna elements to increase scanning capability.

The antennas and/or arrays of the subject technology are based on stable designs that leverage via fencing for large scan angle arrays. The via fencing can be implemented by providing one or more via fences around the antenna (e.g., a via fence between radiator layer and antenna ground layer) or by via fence around the transition region, for example, the region where the feeding structure terminates and the signal transition to a top radiator starts. Fencing can lead to reduction of substrate modes launched into the substrates. The substrate modes are responsible for increasing the element coupling, for increasing cross polarization coupling, for causing diffraction effects at edges of substrate, and for reducing the bandwidth in array configurations. In particular, regarding the antenna bandwidth, when the transition is not fenced, sharp resonances can appear in the feed layers of the antenna due to the excitation of substrate modes. These sharp resonances can result in narrow resonances in the return loss response, as the array is scanned down, indicating a non-stable antenna design.

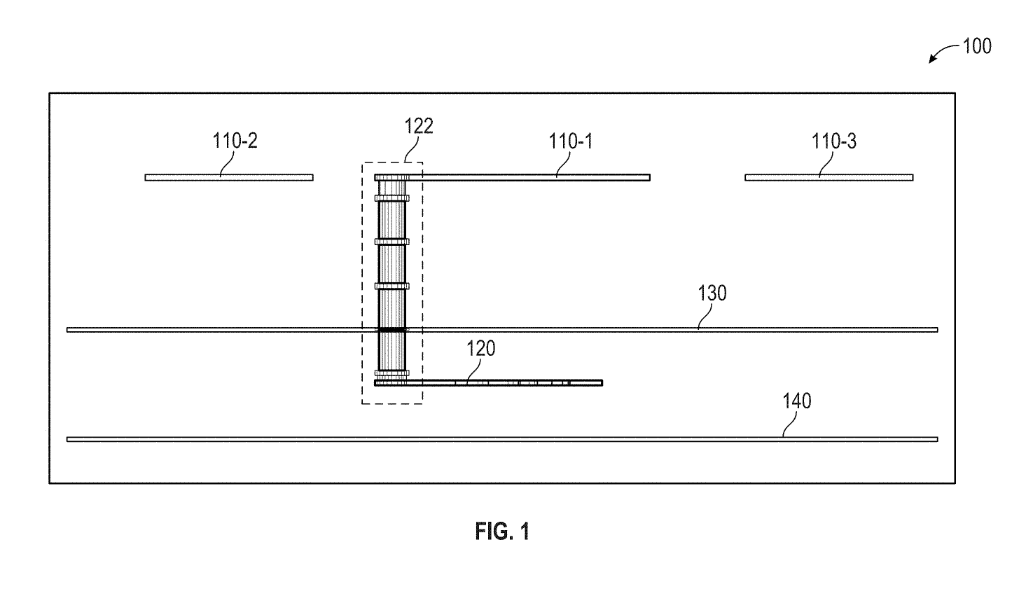

FIG. 1 is a high-level diagram illustrating an example of a broadband antenna element 100 for wireless communications according to aspects of the subject technology. The broadband antenna element 100 includes one or more radiator layers 110 (e.g., 110-1, 110-2, and 110-3), a ground layer 130, a feeding mechanism including a feed layer 120 and stacked vias 122. The antenna element 100 further includes a bottom ground 140 for shielding purposes. Different layers of the antenna element 100 are conductor layers of a multilayer substrate (e.g., a printed circuit board (PCB)) that are separated by dielectric material layers (e.g., layers of alumina, ceramics, or organic substances such as polymers).

The feeding mechanism can feed an excitation such as radio-frequency (RF) signal (e.g., current) generated by an RF transmitter (e.g., a high speed transmitter) into the radiator layer 110-1. The stacked vias 122 provide a conductive pass from the feed layer 120, which is coupled to a signal distribution layer (not shown), to the radiator layer 110-1. In some aspects, the stacked vias 122 can have specialized design provisions such as distributed matching circuits at each traversed layer with metalized bridges. Such special design provisions are capable of reducing substrate-mode emanating at the transition regions and propagation within the substrate. In one or more aspects, the radiator layers 110-2 and 110-3 can be excited through capacitive coupling to the radiator layer 110-1. The radiator layers 110 propagate a polarized electromagnetic (EM) wave. The EM wave propagated by the radiator layers 110 can have one of linear, dual, or circular polarization. The antenna element 100 can transmit with a broad bandwidth (e.g., approximately 57-66 GHz) centered at a frequency of about 60 GHz. The antenna element 100, when used in an antenna array can maintain its broad bandwidth and polarization purity for large scan angles (e.g., up to about 60 degrees), as the antenna array beam is steered. Although, in the disclosure herein, the antenna elements are discussed in the context of a transmission application, all disclosed antenna elements or antenna arrays can be used equally well in a receiver to receive with similar broad bandwidth at a center frequency of about 60 GHz.

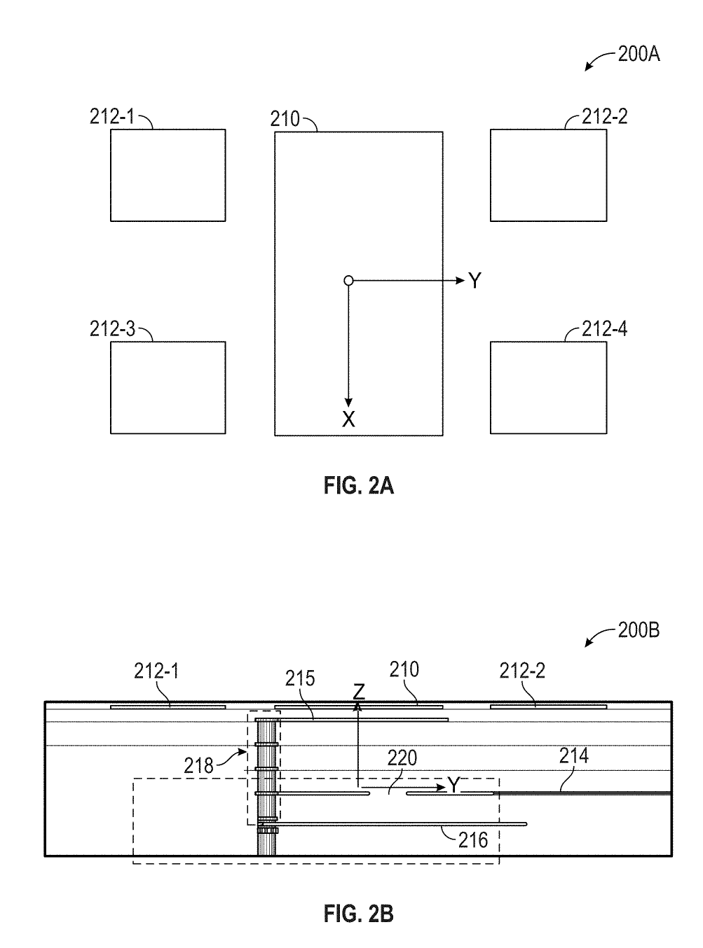

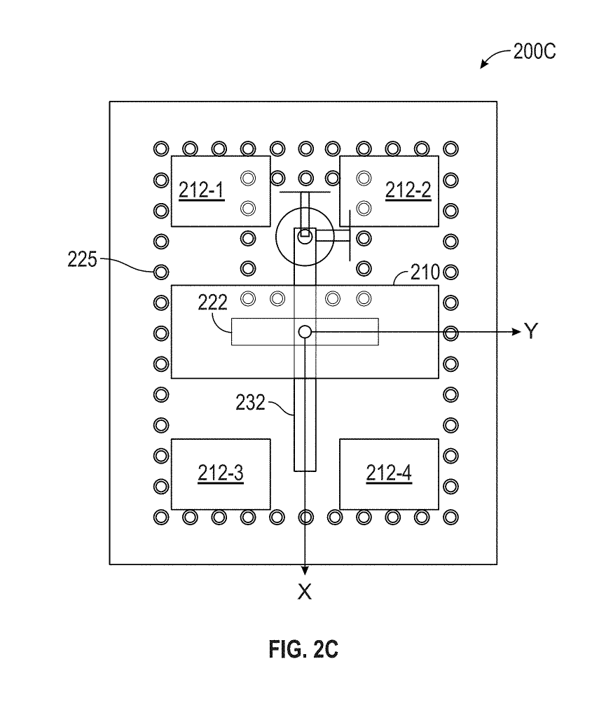

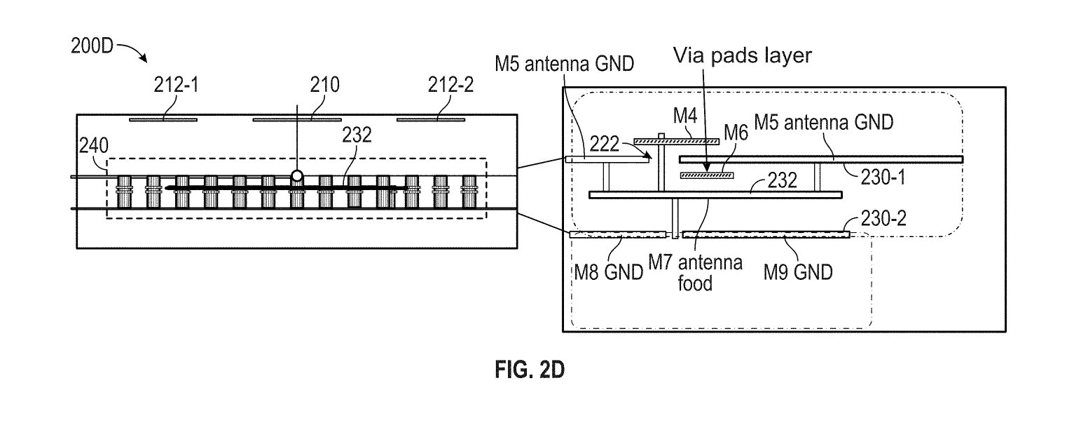

FIGS. 2A through 2D are diagrams illustrating example structural views of a broadband multi-patch antenna element 200A, shown in FIG. 2A for wireless communications according to aspects of the subject technology. The broadband multi-patch antenna element 200A includes one or more of radiator layers including a main patch 210 and a number of parasitic patches 212. For example, the multi-patch antenna element 200A is pentaplet patch antenna with four parasitic patches 212-1 through 212-4. In some aspects, the pentaplet patch antenna can be implemented using a multilayer substrate and the main patch 210 and the parasitic patches 212 are arranged on the top conductor layer for broadband impedance matching purposes. In one or more aspects, the parasitic patches 212 can be aligned or misaligned and can be implemented in a separate conductor layer of the multilayer substrate than the main patch 210.

In the example configuration shown in the cross-sectional view 200B of FIG. 2, the main patch 210 and the parasitic patches 212 are realized on a metal 1 (M1) layer and an auxiliary radiator 215 is implemented on a M2 layer. The auxiliary radiator 215 receives excitation from a feed structure 218. In some aspects, the feed structure 218 is formed by stacked vias, similar to the stacked vias 122 of FIG. 1, and is conductively coupled through a transmission line 216 to a source, such as an output of a wireless transmitter. In some aspect, the EM energy transfer from the auxiliary radiator 215 to the radiator patches (e.g., main patch 210) is through capacitive coupling. A ground layer 214 may be coupled to a ground potential of the transmitter. In some implementations, fencing vias (not shown) are provided around the transmission line 216 to effectively reduce the launching of substrate modes.

While the feeding mechanism in the pentaplet antenna element 200A is through stacked vias (e.g., 218), in the pentaplet antenna element 200C, shown in a top view of FIG. 2C, the feeding is done without any vias. In the pentaplet antenna element 200C, the main patch 210 and the parasitic patches 212 are excited via a slot 222, which in turn receives signals from an antenna feed layer (e.g., a stripline) 232. Fencing vias 225 implemented around the pentaplet antenna element 200C can cut off or reduce substrate-modes. At frequencies of about 60 GHz, the substrate-mode can be easily excited in discontinuities when using thick substrates. The wall of vias 225 around the pentaplet antenna element can effectively prevent launching of the substrate-modes that can result in increased insertion loss and undesired sharp resonances in the return loss.

The slot 220 is a gap in the ground layer 230-1 shown in FIG. 2D, and is fed through the antenna feed layer 232. The cross-sectional views 200D shown in FIG. 2D, depicts various metal layers of the substrate used for implementing the pentaplet antenna element 200C. A group of vias 240 provide connection between the antenna feed layer 232, the ground layer 230-1 (e.g., M5 ground) and a ground layer 230-2 (e.g., M9 ground). The vias 240 are essential in the reduction of substrate modes that can be launched into the substrate.

In some implementations, one or more dielectric layers can be used to achieve a desired ground to radiator layer height. In some aspects, the pentaplet antenna elements 200A or 200C can be used to implement an array antenna with multiple elements. The array antenna can be steered to large angles (e.g., 60 degrees) and still maintain a broad bandwidth of about 57-66 GHz with a band edge margin of about 0.5-1 GHz. In one or more aspects, the pentaplet antenna elements 200A or 200C are linearly polarized in the Y direction.

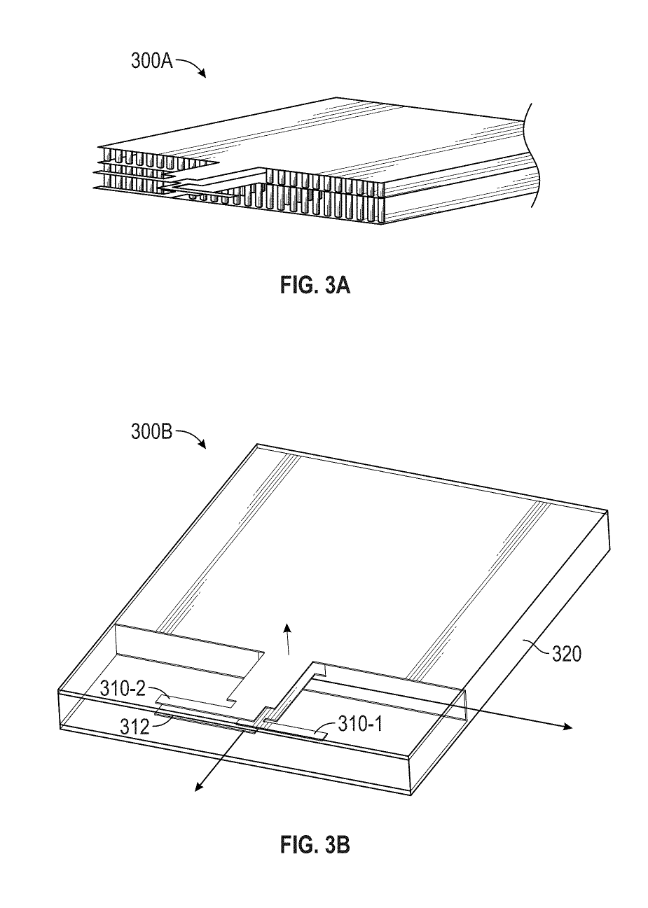

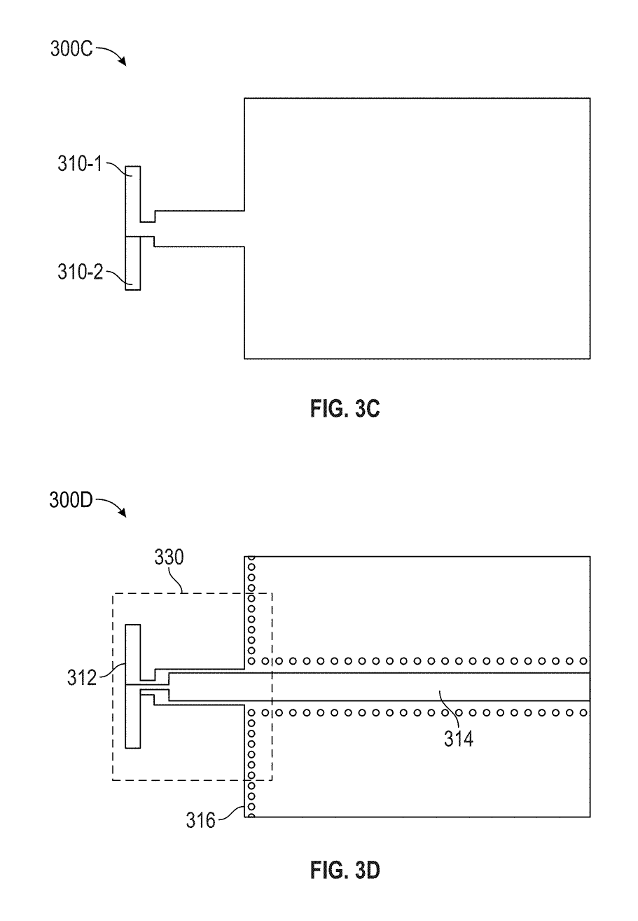

FIGS. 3A through 3D are diagrams illustrating example structural views of a broadband edge-dipole antenna element 300A for wireless communications according to aspects of the subject technology. FIG. 3A shows a perspective view of broadband edge-dipole antenna element 300A, which can be implemented on a low-cost PCB material such as an organic laminate (e.g., a six metal layer substrate 2-2-2) and is readily portable to other substrates. The edge view 300B shows the main components of the edge-dipole antenna element as being a protruded portion including a feed layer 312 and at least one radiator layer 310-1 or 310-2. The protruded portion is an extension of a body portion 320 that can be used to host one or more electronic chips such as an RF transceiver to reduce RF transmission losses. Further, one or more heat sinks can be implemented on the body portion 320 alongside the antenna element.

Each of the radiator layers 310-1 and 310-2 include an approximately quarter-wavelength radiator member extending in one direction, as shown in the view 300C of FIG. 3C. In some aspects, the radiator layers 310-1 and 310-2 are realized on two separate conductor layers of the multilayer substrate, for example, on M1 and M3 layers. The feed layer 312 can be implemented in between the two radiator layers 310-1 and 310-2, for example on M2 layer. The feed layer 312 includes a feed member extending in two directions as the radiator members of the radiator layers 310-1 and 310-2 are. The feed layer 312 is connected to a stripline 314. A portion 330 including the stripline 314 and the feed layer 312 functions as a distributed balun as it converts an unbalanced signal at the stripline 314 to balanced signals induced in the two approximately quarter-wavelength radiator members of the radiator layers 310-1 and 310-2. In one or more aspects, the edge-dipole antenna element, as shown in the view 300D, further includes fencing vias 316 that can drastically reduce launching of the substrate-modes. A number (e.g., 8 or 16) of the edge-dipole antenna elements can be implemented on a substrate to from an antenna array, the beam of which can be steered by dephasing the signals to or from the individual antenna elements.

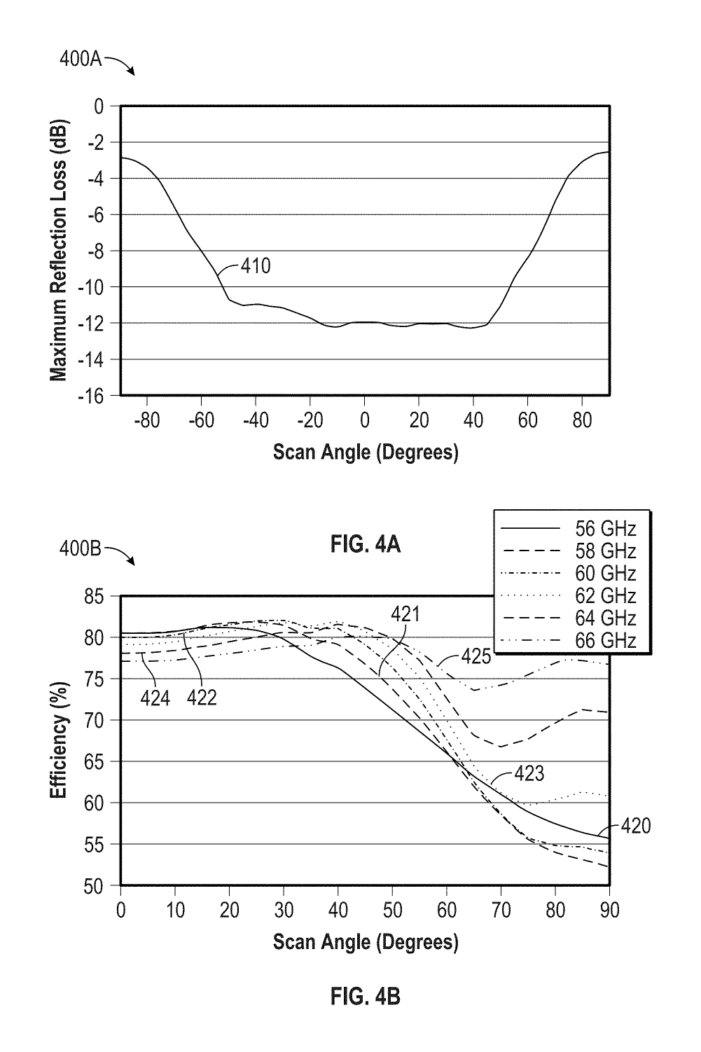

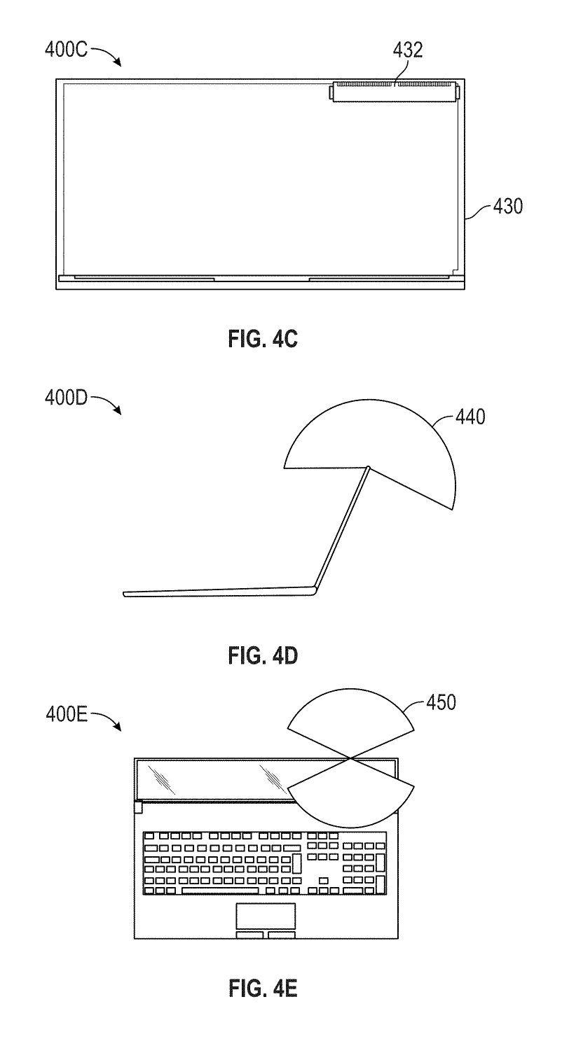

FIGS. 4A through 4E are diagrams illustrating example characteristics of the edge-dipole antenna element of FIG. 3A according to aspects of the subject technology. The characteristics 400A shown in FIG. 4A is a plot 410 of maximum reflection loss (dB) versus scan angle (degrees) for an 8-element edge-dipole antenna array. The characteristics 400B depicted in FIG. 4B, shows plots 420 through 425 of the array element efficiency (%) versus scan angle (degrees) at an approximate frequency range of 56 GHz to 66 GHz, in about 2 GHz steps. For example, at about 60 GHz, the efficiency drops by about 10 dB at a scan angle of about 60 degrees.

Other example characteristics of the disclosed edge-dipole antenna array include a maximum realized gain of about 14.5 dBi, a minimum steered beam width of about 7° (e.g., in the plane of the array), a −3 dB beam width of approximately 210°, a −6 dB beam width of about 260° (e.g., perpendicular to the plane of the array), an impedance field of view of about 100° (e.g., Sₙₙ better than about −10 dB), and a realized gain field of view of >120°. Further, an input impedance of each antenna element is matched to 15Ω, routing is done at 15Ω to minimize losses, and antenna element input impedance is transformed to 50 ohms using, for example, a 1.25 mm (e.g., half wavelength) Klopfenstein impedance transformer.

A diagram 400C shows location of an example edge-dipole antenna element array 432 on a laptop computer 430. Diagram 400D and 400E show example radiation patterns 440 and 450 of the edge-dipole antenna element array 432.

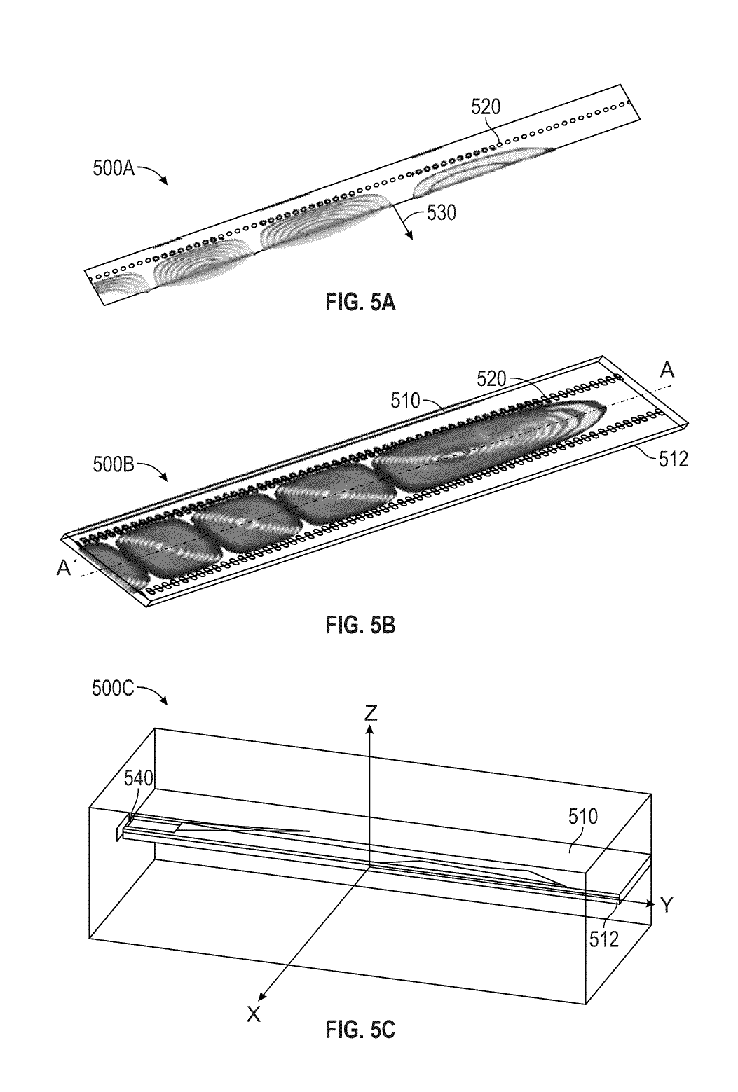

FIGS. 5A through 5C are diagrams illustrating examples of a broadband half-mode substrate-integrated waveguide (HMSIW) antenna element 500A for wireless communications according to aspects of the subject technology. The HMSIW antenna element 500A of the subject technology, as shown in FIG. 5A is half of a SIW antenna element 500B of FIG. 5B, as cut along a middle line AA′, as depicted in FIG. 5B. The HMSIW antenna element 500A, includes top and bottom radiator layers 510 and 512, as shown in FIG. 5B, which are coupled to one another by vias of fencing vias 520 and are separated by a dielectric material. The HMSIW antenna element 500A can radiate from the edge of the substrate in a direction shown by the arrow 530.

The fencing vias 520, as explained above, improve insertion loss by drastically reducing the substrate-modes. A three-dimensional view 500C, depicted in FIG. 5C, shows the top radiator layer 510 is coupled to a feed micro-stripline 540. The top radiator layer 510, bottom radiator layer 512, and the feed micro-stripline 540 are coupled to an antenna ground. In some implementations, the length along the Y axis of the HMSIW antenna element shown in FIG. 5C can be about 10 mm.

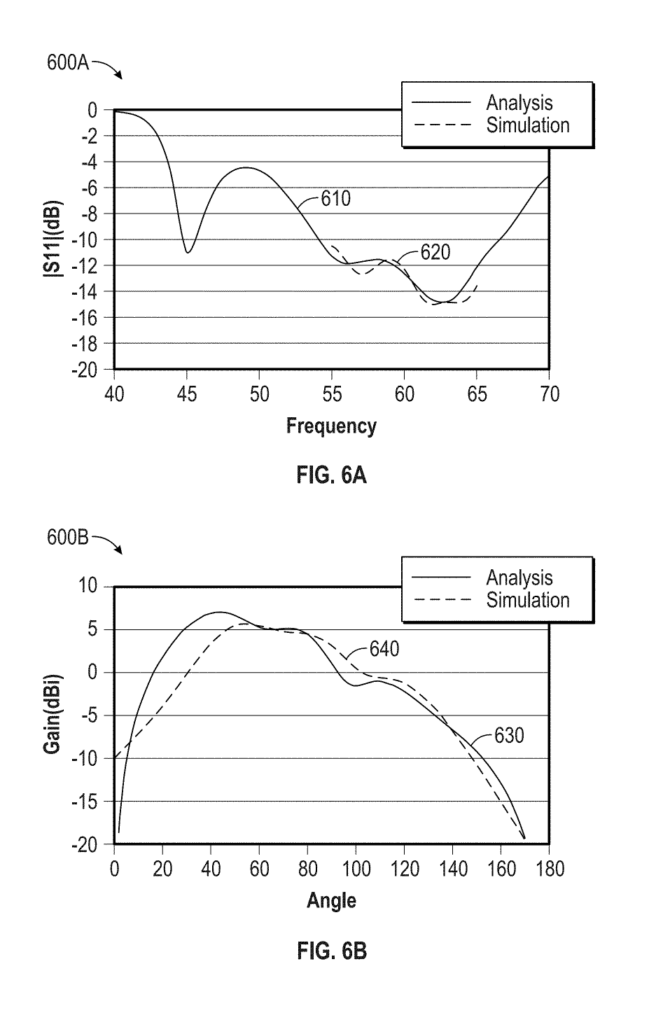

FIGS. 6A-6B are diagrams illustrating example characteristics of the HMSIW antenna element 500A of FIG. 5A according to aspects of the subject technology. Diagram 600A of FIG. 6A shows plots 610 and 620 of the return loss (S₁₁) in dB versus frequency of a single HMSIW antenna element designed for the 55-65 GHz frequency range. The plots 610 and 620 are the result of a theoretical analysis and computer simulation, respectively, and are quite similar. Diagram 600B of FIG. 6B shows plots 630 and 640 of gain (dB) versus scan angle of a single HMSIW antenna element of the subject technology. The plots 630 and 640 are the result of a theoretical analysis and computer simulation, respectively, and are seen to closely follow one another and show a broad radiation pattern. Thus the HMSIW antenna element is an omni-directional antenna element with a bandwidth of about 55-65 GHz, and the horizontal polarization of the HMSIW antenna can be maintained for scan angles up to about 150 degrees.

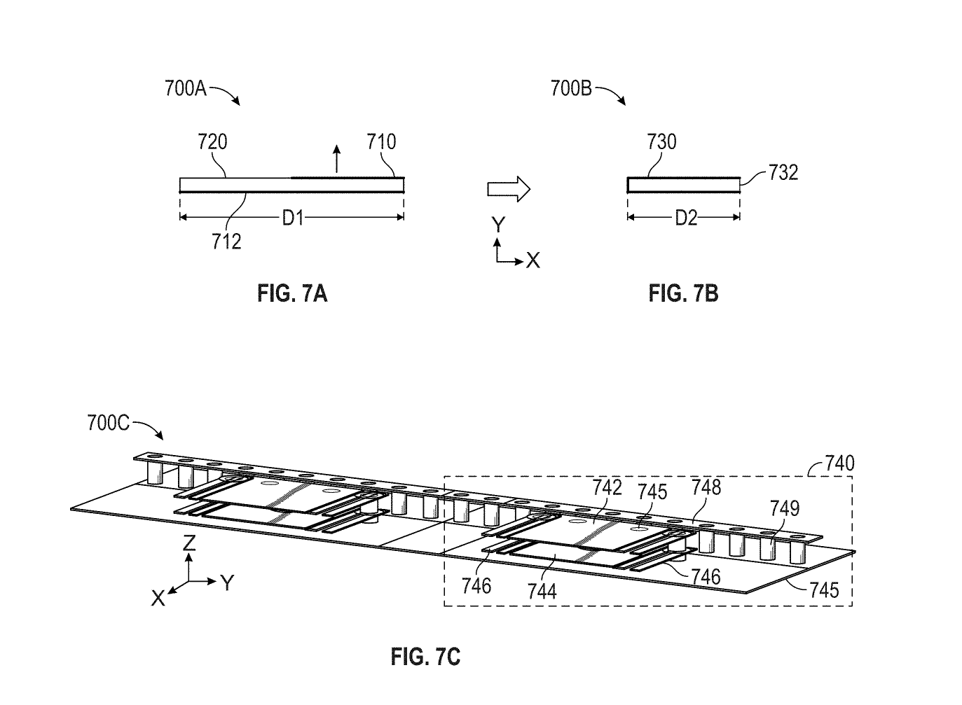

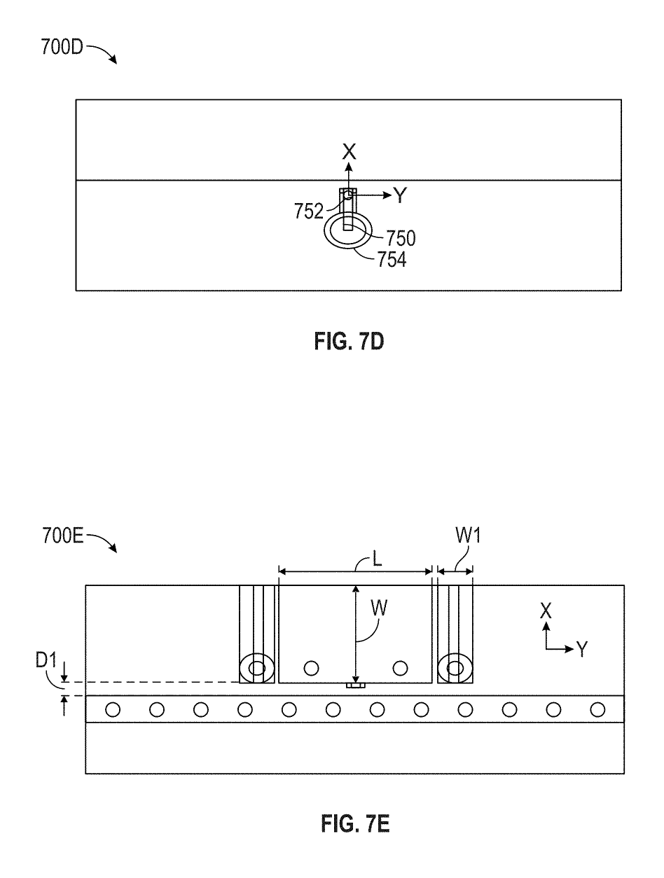

FIGS. 7A through 7E are diagrams illustrating example configurations of a broadband folded-patch antenna element 700B for wireless communications according to aspects of the subject technology. The antenna element 700A is a planar antenna element that includes a radiator layer 710, a ground layer 712, and a dielectric material 720, the direction of highest radiation for which is in the direction Y vertical to the plane of the radiator layer 710. The length D1 of the antenna element 700A along the X axis is approximately half of the wavelength (λ) corresponding to the ˜60 GHz frequency in the dielectric material 720. The conceptual diagram depicted in FIG. 7B shows the disclosed folded-patch antenna element 700B as being shaped by folding the ground layer 712 and combing it with the radiator layer 710 to make the folded radiator 730. The folded-patch antenna element 700B is a vertically polarized edge antenna element that radiates in a direction X parallel to the plane of the radiator 730 from the open end 732 of the antenna element. The length D2 of the folded-patch antenna element 700B along the X axis is approximately a quarter of wavelength (λ) corresponding to the ˜60 GHz frequency in the dielectric material 720.

A diagram 700C, shown in FIG. 7C, shows implementation of an antenna array formed by two folded-patch antenna elements 740. The implemented folded-patch antenna element 740, includes conductor layer radiator patches 742 and 744, side strips (e.g., parasitic patches) 746 implemented on both sides of the radiator patches 742 and 744, and a shield structure formed by a conductor layer 748 and fencing vias 749. The radiator patches 742 and 744 are coupled to one another through the vias 749 to implement the folded radiator 730 of FIG. 7B. The ground layer 745 (e.g., an M5 of a multilayer substrate) is a solid ground layer that hosts antenna feeding through a coplanar waveguide (CPW) 750 and a via 752 surrounded by an edge guard 754, as shown in the X-Y plain view 700D of FIG. 7D. In some aspects, the radiator patches 742 and 744 and the ground layer 745 are implemented on M1, M4, and M5 metal layers of a multilayer substrate, but are not limited to these layers and can be implemented in other layers as well.

Example values for dimensions as shown in the X-Y plain view 700E of FIG. 7E are given here. A width (W) and a length (L) of the radiator patches 742 and 744 are about 720 and 850 micrometers (μm), respectively. A width W1 across the Y direction of the side strips is about 220 μm, and a distance D1 between the edge of the radiator patch 742 and an edge of the conductor layer 748 of the shield structure is about 100 μm. The side strips 746 are implemented to enhance the bandwidth of the folded-patch antenna element 740, and the shield structure that can reduce substrate-modes as explained above.

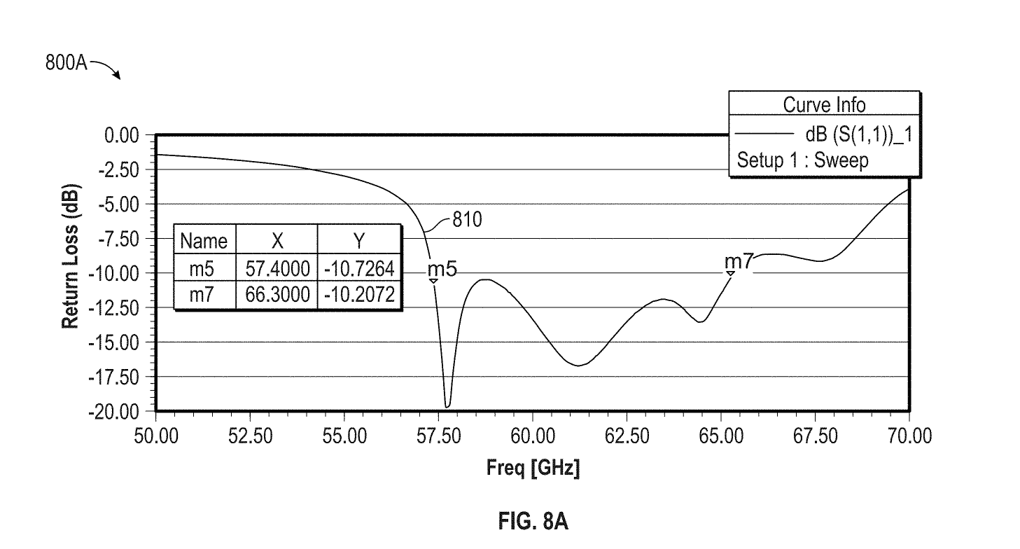

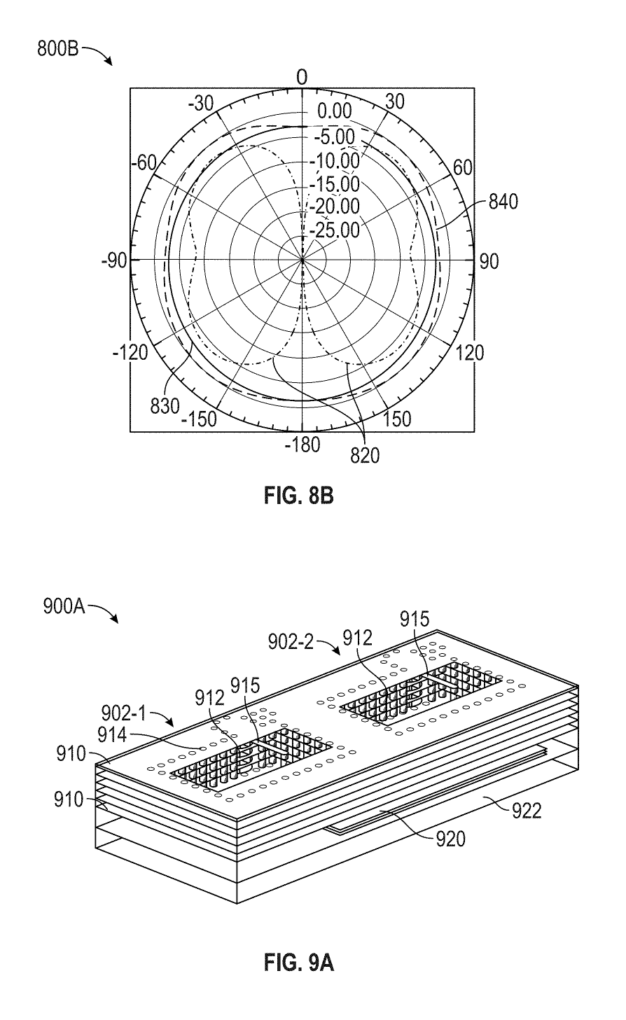

FIGS. 8A-8B are diagrams illustrating example characteristics of the folded-patch antenna element of 740 of FIG. 7C according to aspects of the subject technology. The diagram 800A shown in FIG. 8A is a plot 810 of the return loss (dB) versus frequency for the folded-patch antenna element 740 of FIG. 7C. Based on the plot 810, the antenna element is matched below about −10 dB from about 57.4 to 65.3 GHz, thus covering almost the entire 60 GHz bandwidth.

The diagram 800B depicted in FIG. 8B shows plots 820, 830, and 840 of radiation pattern of the folded-patch antenna element 740 of FIG. 7C. The plots 820 and 830 represent gains for vertical polarization phi (ϕ) and horizontal polarization theta (θ), and the plot 840 is the total gain. These plots show that the folded patch antenna element 740 has a nearly omni-directional radiation pattern. In some aspects, a radiation efficiency of the disclosed folded-patch antenna element 740 can be about 80%. The vertical polarization is at ϕ˜180 degrees and the polarization is maintained up to scan angles of about +/−130 degrees.

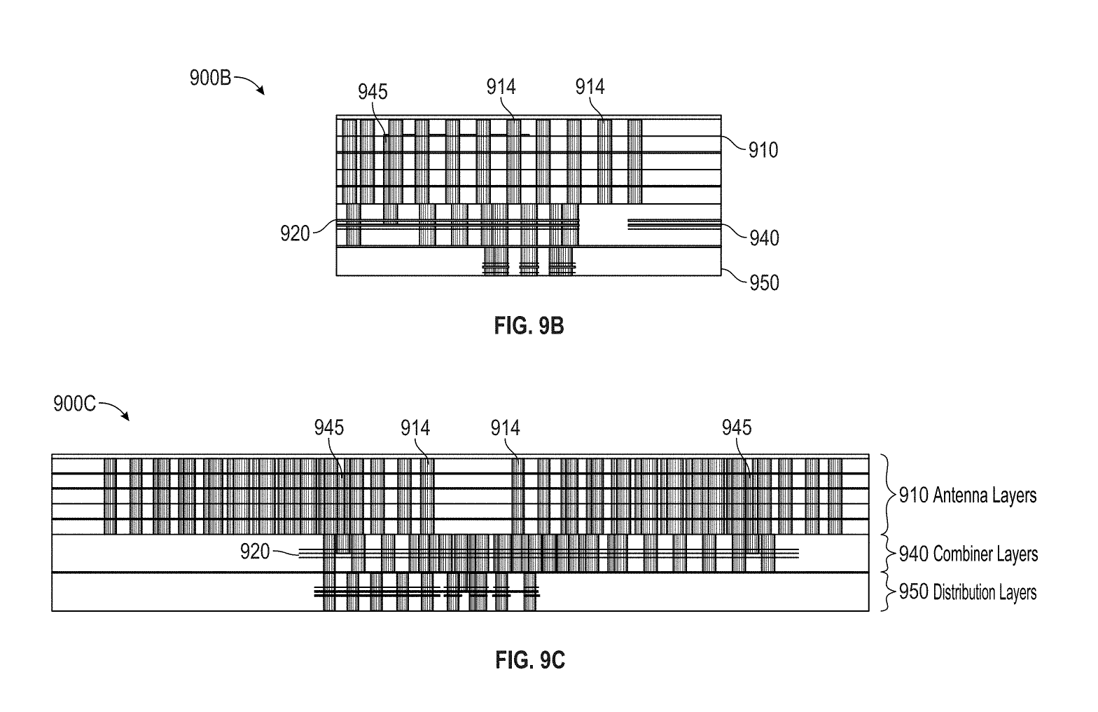

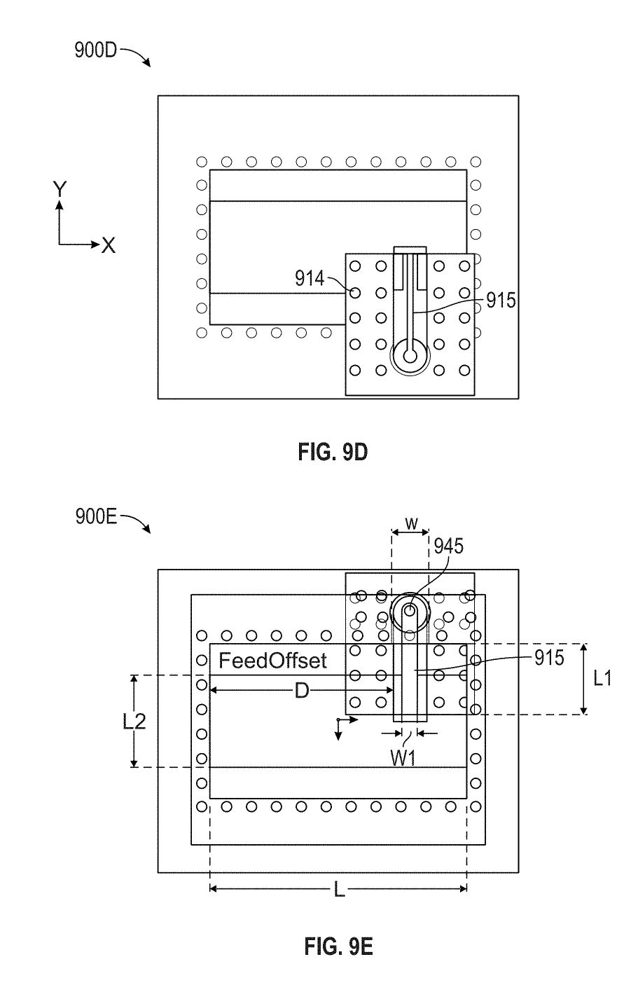

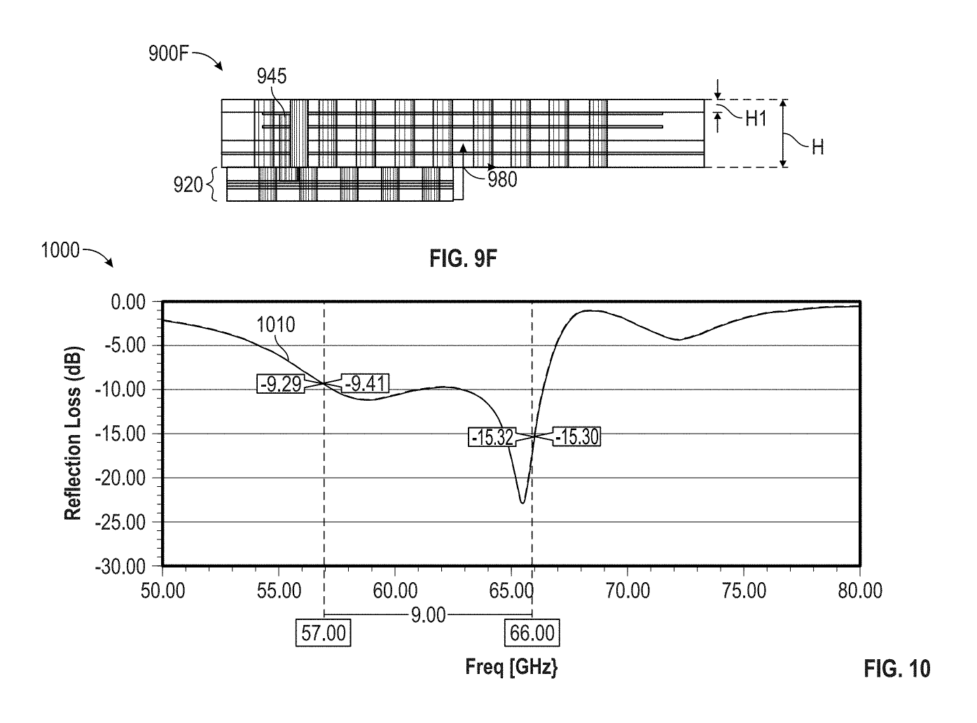

FIGS. 9A through 9F are diagrams illustrating examples of a broadband cavity-slot antenna element 900A for wireless communications according to aspects of the subject technology. The cavity-slot antenna 900A depicted in FIG. 9A shows two side-by-side cavity-slot antenna elements 902-1 and 902-2 formed of conductor layers 910 of a multilayer substrate including cavities 912. Walls of each cavity 912 are formed by fencing vias 914 that pass through all layers 910. Feed micro-strip 915 is coupled through a via 945 shown in the side-view diagram 900B of FIG. 9B from the feed layer 920 (e.g. a ground layer below the cavity) to the top conductor (radiator) of the conductor layers 910. The side-view diagram 900B in the Y-Z plane shows the antenna layers 910, combiner layers 940, distribution layers 950, and a transition via 945 that couples the feed micro-strip 915 to the feed layer 920. The side-view diagram 900C in the X-Z plane shows another view of the antenna layers 910, combiner layers 940, distribution layers 950, transition vias 945, and the feed layer 920. In some implementations, the cavity 912 is filled with a low temperature co-fired ceramic (LTCC).

A diagram 900D of FIG. 9D shows a bottom view of the cavity-slot antenna 900A, where the fencing vias 914 around the feed area including the feed micro-strip 915 are shown. In the top view 900E of FIG. 9E and the side view 900F of FIG. 9F example values of a number of lengths and distances, such as L (e.g., about 2 mm), L1 (e.g., about 550 μm), L2 (e.g., about 700 μm), feed offset D (e.g., about 1500 μm), a width W1 (e.g., about 110 μm), a width W (e.g., about 270 μm), a height H (e.g., about 500 μm), and a height H1 (e.g., about 100 μm) are given. The width W and W1 correspond to the width of a guard ring around the transition via 945 and the width of the feed 915, respectively. The heights H and H1 correspond to the cavity height and a distance of the top layer of the antenna layer 910 from the top of the antenna multi-layer substrate, and the point 980, shown in FIG. 9F, is a feed point for the antenna element.

FIG. 10 is a diagram illustrating an example characteristic of the cavity-slot antenna element 902 of FIG. 9A according to aspects of the subject technology. The diagram 1000 of FIG. 10 shows a plot 1010 of return loss (dB) versus frequency (GHz) for the cavity-slot antenna element 902. The plot 1010 indicates a matching below about −9.5 dB within the approximate range of 57 to 66 GHz. In some aspects, a realized gain of the cavity-slot antenna element 902 increases from about 57 to about 66 GHz in an approximate range of 3.7-4.7 dBs.

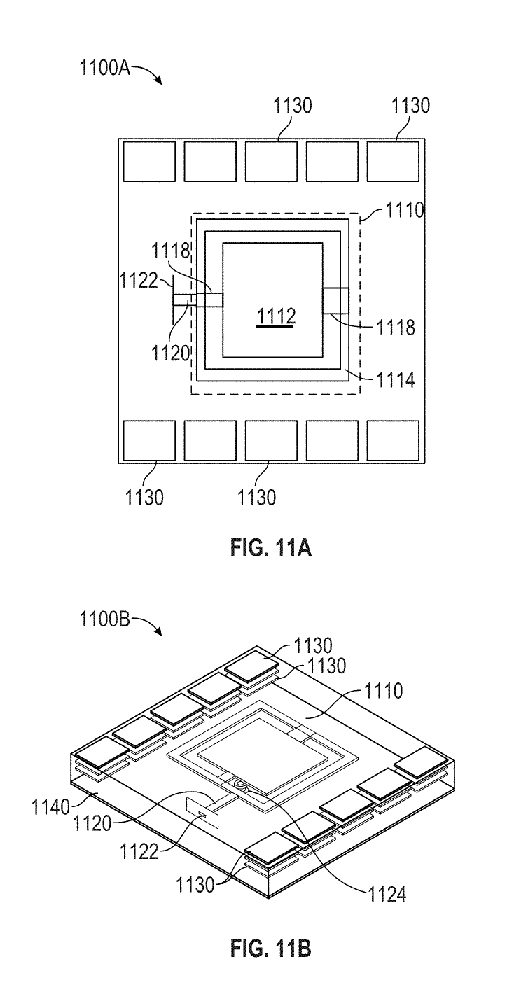

FIGS. 11A-11B are diagrams illustrating a top view 1100A and a perspective view 1100B, respectively, of an example of a ring antenna element for wireless communications according to aspects of the subject technology. The ring antenna element shown in the top view 1100A includes a radiator 1110, a feed mechanism including a feed layer 1120 coupling a feed port 1122 to the radiator 1110, and a number of parasitic patches 1130. The radiator 1110 includes a center patch 1112, a ring 1114 surround the center patch 1112, and one or two interconnect strips 1118. In one or more aspects, the radiator 1110, the feed layer 1120, and the parasitic patches 1130 are metallic layers, the entire antenna dimensions can be approximately 2.35×2.5 mm where the dimensions of the radiator 1110 is approximately 1.116 mm×1.26 mm depending on technology and substrate used. In some aspects, the dimensions and configuration of the radiator 1110, including the dimensions of the interconnect strips 1118, depends on the technology, properties (e.g., dielectric properties such as dielectric constant) of a substrate that the antenna element is formed on, and a desired bandwidth. In some aspects, the antenna element shown in the top view 1100A can be used to implement an array such as a linear or a two-dimensional array, which enables beamforming and beam scanning.

In some implementations, as shown in the perspective view 1100B of FIG. 11B, the parasitic patches 1130 are provided on more than one layer, for example, the top layer (that includes the radiator 1110) and one or more other layers below the top layer. The parasitic patches 1130 are useful in impedance matching of the antenna element, and their dimensions and their number can be varied to provide desired impedance matching (e.g., less than −10 dB). Further, the parasitic patches 1130 can be beneficial in maintaining the desired bandwidth (e.g., 57-66 GHz) for the antenna and a wider scanning angle (e.g., −45 degrees to +45 degrees), when used in an antenna array configuration. As shown in the perspective view 1100B, the feed layer 1120 is coupled to the radiator 1110 through a via 1124. In some aspects, the ground layer 1140 can be implemented as the bottom layer of the antenna element structure.

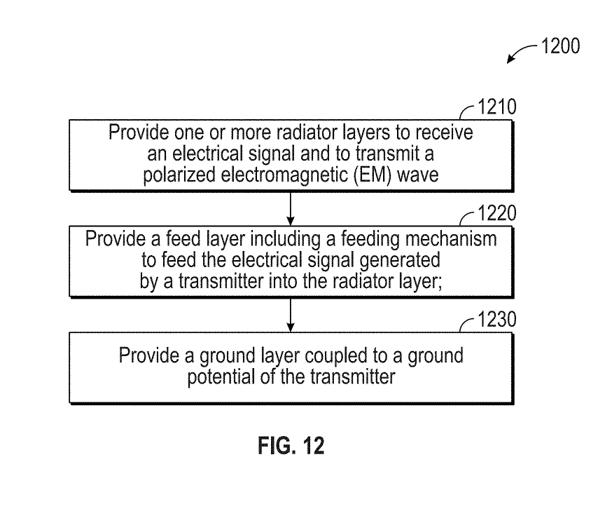

FIG. 12 is flow diagram illustrating a method 1200 of providing a broadband antenna element (e.g., 100 of FIG. 1, 200A and 200C of FIGS. 2A and 2C, 300A of FIG. 3A, 500A of FIG. 5A, 740 of FIG. 7C, and 900A of FIG. 9A) for wireless communications according to aspects of the subject technology. The method 1200 start with providing one or more radiator layers (e.g., 110 of FIG. 1) to receive an electrical signal and to transmit a polarized electromagnetic (EM) wave (1210). A feed layer (e.g., 120 of FIG. 1) including a feeding mechanism (e.g., 122 of FIG. 1) is provided to feed the electrical signal generated by a transmitter into the radiator layer (1220). A ground layer (e.g., 130 of FIG. 1) coupled to a ground potential of the transmitter is provided (1230).

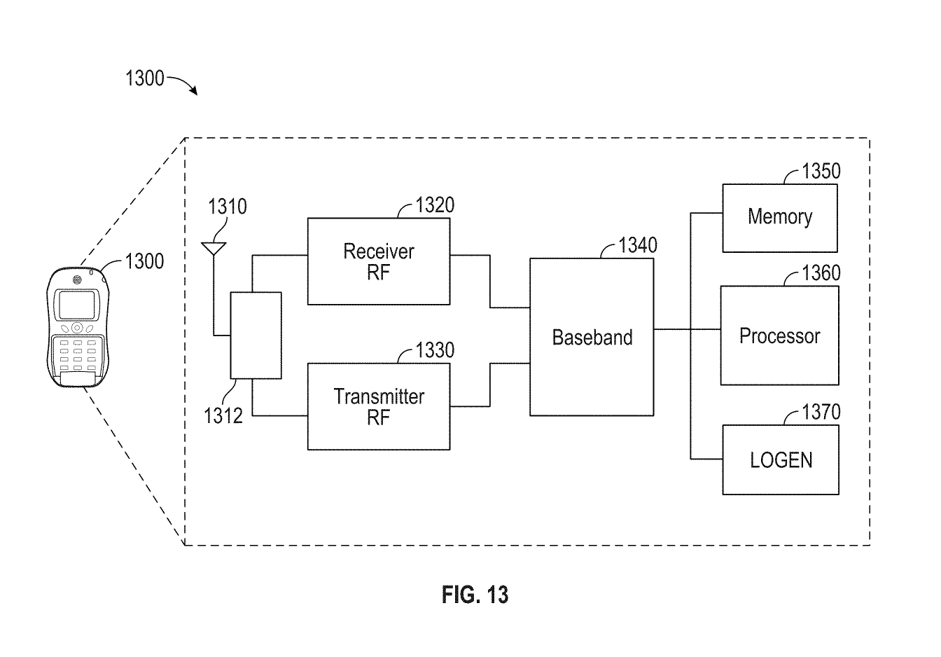

FIG. 13 is a block diagram illustrating an example wireless communication device 1300 in accordance with one or more implementations of the subject technology. The wireless communication device 1300 may comprise a radio-frequency (RF) antenna 1310, a receiver 1320, a transmitter 1330, a baseband processing module 1340, a memory 1350, a processor 1360, and a local oscillator generator (LOGEN) 1370. In various embodiments of the subject technology, one or more of the blocks represented in FIG. 13 may be integrated on one or more semiconductor substrates. For example, the blocks 1320-1370 may be realized in a single chip or a single system on chip, or may be realized in a multi-chip chipset.

The RF antenna 1310 may be suitable for transmitting and/or receiving RF signals (e.g., wireless signals) over a wide range of frequencies (e.g., 60 GHz band). Although a single RF antenna 1310 is illustrated, the subject technology is not so limited. In some aspects, the RF antenna 1310 may be realized by using antenna array elements of the subject technology, for example, the antenna elements 100 of FIG. 1, 200A and 200C of FIGS. 2A and 2C, 300A of FIG. 3A, 500A of FIG. 5A, 740 of FIG. 7C, or 900A of FIG. 9A, as described above.

The receiver 1320 may comprise suitable logic circuitry and/or code that may be operable to receive and process signals from the RF antenna 1310. The receiver 1320 may, for example, be operable to amplify and/or down-convert received wireless signals. In various embodiments of the subject technology, the receiver 1320 may be operable to cancel noise in received signals and may be linear over a wide range of frequencies. In this manner, the receiver 1320 may be suitable for receiving signals in accordance with a variety of wireless standards. Wi-Fi, WiMAX, Bluetooth, and various cellular standards. In various embodiments of the subject technology, the receiver 1320 may not require any SAW filters and few or no off-chip discrete components such as large capacitors and inductors.

The transmitter 1330 may comprise suitable logic circuitry and/or code that may be operable to process and transmit signals from the RF antenna 1310. The transmitter 1330 may, for example, be operable to up-convert baseband signals to RF signals and amplify RF signals. In various embodiments of the subject technology, the transmitter 1330 may be operable to up-convert and amplify baseband signals processed in accordance with a variety of wireless standards. Examples of such standards may include Wi-Fi, WiMAX, Bluetooth, and various cellular standards. In various embodiments of the subject technology, the transmitter 1330 may be operable to provide signals for further amplification by one or more power amplifiers.

The duplexer 1312 may provide isolation in the transmit band to avoid saturation of the receiver 1320 or damaging parts of the receiver 1320, and to relax one or more design requirements of the receiver 1320. Furthermore, the duplexer 1312 may attenuate the noise in the receive band. The duplexer may be operable in multiple frequency bands of various wireless standards.

The baseband processing module 1340 may comprise suitable logic, circuitry, interfaces, and/or code that may be operable to perform processing of baseband signals. The baseband processing module 1340 may, for example, analyze received signals and generate control and/or feedback signals for configuring various components of the wireless communication device 1300 such as the receiver 1320. The baseband processing module 1340 may be operable to encode, decode, transcode, modulate, demodulate, encrypt, decrypt, scramble, descramble, and/or otherwise process data in accordance with one or more wireless standards.

The processor 1360 may comprise suitable logic, circuitry, and/or code that may enable processing data and/or controlling operations of the wireless communication device 1300. In this regard, the processor 1360 may be enabled to provide control signals to various other portions of the wireless communication device 1300. The processor 1360 may also control transfers of data between various portions of the wireless communication device 1300. Additionally, the processor 1360 may enable implementation of an operating system or otherwise execute code to manage operations of the wireless communication device 1300.

The memory 1350 may comprise suitable logic, circuitry, and/or code that may enable storage of various types of information such as received data, generated data, code, and/or configuration information. The memory 1350 may comprise, for example, RAM, ROM, flash, and/or magnetic storage. In various embodiment of the subject technology, Information stored in the memory 1350 may be utilized for configuring the receiver 1320 and/or the baseband processing module 1340.

The local oscillator generator (LOGEN) 1370 may comprise suitable logic, circuitry, interfaces, and/or code that may be operable to generate one or more oscillating signals of one or more frequencies. The LOGEN 1370 may be operable to generate digital and/or analog signals. In this manner, the LOGEN 1370 may be operable to generate one or more clock signals and/or sinusoidal signals. Characteristics of the oscillating signals such as the frequency and duty cycle may be determined based on one or more control signals from, for example, the processor 1360 and/or the baseband processing module 1340.

In operation, the processor 1360 may configure the various components of the wireless communication device 1300 based on a wireless standard according to which it is desired to receive signals. Wireless signals may be received via the RF antenna 1310 and amplified and down-converted by the receiver 1320. The baseband processing module 1340 may perform noise estimation and/or noise cancellation, decoding, and/or demodulation of the baseband signals. In this manner, information in the received signal may be recovered and utilized appropriately. For example, the information may be audio and/or video to be presented to a user of the wireless communication device, data to be stored to the memory 1350, and/or information affecting and/or enabling operation of the wireless communication device 1300. The baseband processing module 1340 may modulate, encode and perform other processing on audio, video, and/or control signals to be transmitted by the transmitter 1330 in accordance to various wireless standards.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A broadband antenna element for wireless communications, the antenna element comprising:
one or more radiator layers configured to receive an electrical signal and to transmit a polarized electromagnetic (EM) wave;
a feeding mechanism including a feed layer configured to feed the electrical signal generated by a transmitter into the radiator layer; and
a ground layer coupled to a ground potential of the transmitter,
wherein:
the one or more radiator layers, the feed layer, and the ground layer are conductor layers of a multilayer substrate including metal layers and dielectric layers,
the antenna element is configured to transmit with a broad bandwidth centered at a predetermined center frequency, and
when used to form an antenna array, the antenna element is configured to maintain the broad bandwidth and polarization purity for scan angles up to a predefined value.

2. The antenna element of claim 1, wherein the one or more radiator layers comprise a main patch and a plurality of parasitic patches, wherein the plurality of parasitic patches include four parasitic patches.

3. The antenna element of claim 2, wherein the predetermined center is about 60 Gigahertz (GHz), and wherein the broad bandwidth is at least about 10 GHz, and wherein the predefined value is at least about 60 degrees, and wherein the antenna element further includes fencing vias at least one of which is around the antenna element or around a transition region.

4. The antenna element of claim 2, wherein the four parasitic patches are aligned and are arranged to form an H-shape, and wherein the parasitic patches are formed on a different layer of a multilayer substrate than the main patch.

5. The antenna element of claim 2, wherein the feeding mechanism includes a stripline fed slot in the ground layer.

6. The antenna element of claim 2, wherein the feeding mechanism include one or more vias coupling the feed layer to the radiator layer, wherein the one or more vias further couple the feed layer to a secondary radiator layer with capacitive coupling to the main patch.

7. The antenna element of claim 1, wherein the predetermined center is about 60 GHz, and wherein the antenna element comprises an edge-dipole element, and wherein the edge-dipole element comprises a distributed balun.

8. The antenna element of claim 7, wherein edge-dipole element comprises protruded portions, wherein the protruded portions include the feed layer and at least two radiator layers.

9. The antenna element of claim 8, wherein a radiator layer of the two radiator layers comprises an approximately quarter-wavelength radiator member extending in one direction.

10. The antenna element of claim 9, wherein the feed layer is in close proximity to the two radiator layers and includes a feed member extending in two directions, and wherein the antenna element further includes fencing vias.

11. The antenna element of claim 1, wherein the predetermined center is about 60 GHz, and wherein the antenna element comprises a cavity-slot antenna element, wherein a cavity-slot is implemented using vias-fence walls connecting at least three radiator layers.

12. The antenna element of claim 11, wherein the feed mechanism includes a signal feed transition from the ground layer that is below the cavity-slot to a top radiator layer, and wherein the cavity-slot is filled with a low temperature co-fired ceramic (LTCC).

13. The antenna element of claim 1, wherein the predetermined center is about 60 GHz, and wherein the antenna element comprises a folded-patch antenna element, wherein the one or more radiator layer comprise two radiator layers connected through vias at one side to form a folded patch.

14. The antenna element of claim 13, wherein the feed mechanism includes a coplanar waveguide (CPW) line coupled to the ground layer, and further comprising side strips on both sides of the folded-patch to maintain a bandwidth of about 10 GHz for scan angles up to +/−60 degrees in an array configuration.

15. The antenna element of claim 13, wherein the folded-patch antenna element is configured to provide a nearly omni-directional pattern with an efficiency of about 80% and a vertical polarization maintained for scan angles up to 130 degrees when such antenna is found in an array configuration.

16. The antenna element of claim 13, further comprising a shield structure implemented along a non-radiating side of the folded-patch with a shield layer coupled to the ground layer using a plurality of vias.

17. The antenna element of claim 1, wherein the antenna element comprises a half-mode substrate-integrated waveguide (HMSIW) antenna, wherein the feed layer comprises a micro-strip structure, wherein the one or more radiator layers comprise two radiator layers connected to one another through fence-vias implemented on a non-radiating side of the two radiator layers, and wherein the ground layer comprises the two radiator layers.

18. The antenna element of claim 17, wherein the antenna element comprises an omni-directional antenna element with a bandwidth of about 57-66 GHz at the predetermined center of about 60 GHz, and wherein the polarization purity is maintained for scan angles up to about 150 degrees.

19. The antenna element of claim 1, wherein the predetermined center is about 60 GHz, and wherein the one or more radiator layers comprise a radiator layer including a center patch and a ring coupled to the center patch through one or two interconnect strips.

20. The antenna element of claim 19, wherein the feed layer is coupled to the radiator layer through a via, wherein the ground layer is below the feed layer.

21. The antenna element of claim 19, further comprising a plurality of parasitic patches on one or two sides of the radiator layer and configured to provide an impedance matching of the antenna element and to enhance a bandwidth and a scanning angle width of the antenna array when used to form the antenna array, and wherein the plurality of parasitic patches are implemented on one or more than one single layer.

22. A broadband antenna element for wireless communications, the antenna element comprising:
one or more radiator conductors configured to receive an electrical current and to transmit a polarized electromagnetic (EM) wave;
a feeding mechanism configured to feed an electrical signal generated by a transmitter into the one or more radiator conductors; and
a ground conductor coupled to a ground potential of the transmitter,
wherein:
the one or more radiator conductors, the feeding mechanism, and the ground conductor comprise conductors of a multilayer substrate, and
the antenna element is configured to transmit with a bandwidth of at least approximately 10 GHz centered at a predetermined center frequency.

23. The antenna element of claim 22, wherein the predetermined center is about 60 GHz.

24. A broadband antenna array for wireless communications, the broadband antenna array comprising:
a multilayer substrate; and
a plurality of antenna elements implemented on a multilayer substrate and configured to support beam steering, an antenna elements comprising:
at least one radiator conductor configured to convert an electrical current to a polarized electromagnetic (EM) wave;
a feeding mechanism configured to feed the electrical current generated by a wireless transmitter into a radiator conductor of the at least one radiator conductor; and
a ground conductor coupled to a ground potential of the wireless transmitter,
wherein the antenna element is configured to transmit with a bandwidth of approximately 10 GHz centered at a predetermined center frequency.

25. The antenna element of claim 24, wherein the predetermined center is about 60 GHz.
